(19) United States
(12) Patent Application Publication
(10) Pub. No.: US 2011/0226098 A1
(43) Pub. Date: Sep. 22, 2011

(54) ERGONOMIC HANDLE WITH STORAGE CHAMBER AND DRIVER INCORPORATING THE SAME

(75) Inventor: Yu Jun ZHANG, Songjiang, Shanghai (CN)

(73) Assignee: MERIDIAN INTERNATIONAL CO., LTD., Songjiang (CN)

(21) Appl. No.: 12/789,141

(22) Filed: May 27, 2010

(30) Foreign Application Priority Data
Mar. 19, 2010 (CN) 201020137687.0
Mar. 19, 2010 (CN) 2010201376989

(51) Int. Cl. B25G 1/08; B25B 15/04

(52) U.S. Cl. 81/177.4; 81/60

(57) ABSTRACT

An ergonomic handle for a rotatable device is provided. The handle has an underside, an opposed upperside and a peripheral wall extending therebetween. The upperside has a slightly convex shape providing an ergonomic grip adapted to be received in the palm of a users hand. A ratcheting mechanism is combined with the underside and centered on a center line extending through the handle, wherein the center line represents an axis of rotation for the ratcheting mechanism and. The handle has at least one chamber disposed within the handle body between the upperside and the underside with access to the chamber by a lid disposed on the peripheral wall. A portion of the peripheral wall adjacent to one side of the lid has substantially the same plan outline as the side of the lid, thereby forming a smooth transition between the peripheral wall and the lid.

### CROSS-REFERENCE TO RELATED APPLICATIONS

The present application claims the benefit of Chinese Application 2010201376989 filed Mar. 19, 2010 and Chinese Application 201020137687.0 filed Mar. 19, 2010, which is incorporated herein by reference.

### TECHNICAL FIELD

This disclosure pertains to drivers and more particularly to a driver having an ergonomic handle for storing interchangeable bits.

### BACKGROUND

The variety of screwdriver bit sizes and types which are required for most purposes makes it practical and economical to utilize a screwdriver handle having interchangeable bits. Various designs are in use wherein a single screwdriver handle can be fitted with multiple interchangeable bits where such bits can be stored in the handle, thereby reducing the number and expense of screwdriver tools required to drive the various sizes and head configurations of screws. In the most common of these designs, the multiple bits are stored loosely in a hollow handle. To select a particular bit, an end cap on the handle is unscrewed, all the bits are removed from the handle, the desired bit is selected and secured in a chuck, the remaining bits are returned to the handle and the end cap is replaced.

While such prior handle shapes have functioned acceptably, they have generally been uncomfortable, particularly in cases of extended use.

### SUMMARY

An ergonomic handle for a rotatable device is provided. The handle has an underside, an opposed upperside and a peripheral wall extending therebetween. The upperside has a slightly convex shape providing an ergonomic grip adapted to be received in the palm of a users hand. A ratcheting mechanism is combined with the underside and centered on a center line extending through the handle, wherein the center line represents an axis of rotation for the ratcheting mechanism and. The handle has at least one chamber disposed within the handle body between the upperside and the underside with access to the chamber by a lid disposed on the peripheral wall. A portion of the peripheral wall adjacent to one side of the lid has substantially the same plan outline as the side of the lid, thereby forming a smooth transition between the peripheral wall and the lid.

In an embodiment, the driver has a removable extension member to extend the length of the ratcheting mechanism. The extension member storage receptacle is disposed in a smooth concave recess extending into the handle of the peripheral wall.

### DRAWINGS

For a more complete understanding of particular embodiments and their features and advantages, reference is now made to the following description, taken in conjunction with the accompanying drawings, in which:

FIG. 1 is a perspective view of a preferred embodiment of the ergonomic driver;

FIG. 2 is a perspective view of the preferred embodiment with the lids in the open position;

FIG. 3 is a perspective view of the preferred embodiment with the lids in the closed position; and

FIG. 4 is a top view of the preferred embodiment.

### DETAILED DESCRIPTION

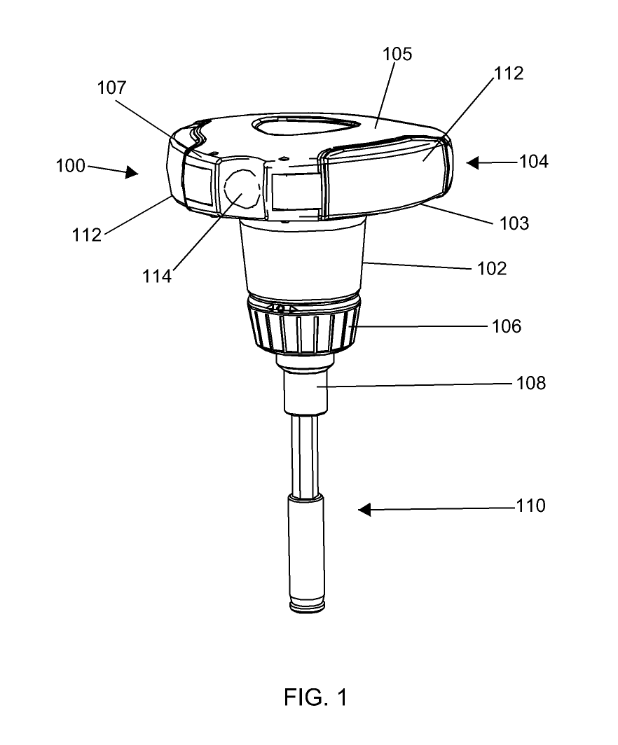

Referring to FIGS. 1-3, disclosed is a preferred embodiment of a driver 100 having an ergonomic handle 104 secured above a body 102 and ratcheting a mechanism 106. Handle 104 includes an underside 103, an opposed upperside 105 adapted to receive the palm of a user's hand, and a peripheral wall 107 extending between the underside and the upperside. Disposed along peripheral wall 107 are one or more lids 112 that form part of peripheral wall 107 to selectively provide access to one or more chambers 116 inside handle 104.

Handle's 104 shape is designed for comfortable gripping by a user's hand. Viewed from the top, handle 104 is substantially triangular in shape with slightly convex sides and rounded angles with a smooth transition or non-angular transition between the respective convex sides. In an alternative embodiment, handle 104 can have a substantially round or polygonal shape with rounded angles, when viewed from the top. The top surface of both embodiments is slightly convex such that the shape of the top surface fits generally into the palm of the user's hand. Furthermore, the total area of an upperside 105 of handle 104 is greater than the combined area of body 102 and ratcheting mechanism 106.

Handle 104 is substantially hollow with one or more chambers 116 inside to provide a place for storing interchangeable bits (not shown) for driver 100. In a preferred embodiment, disposed within chamber 116 is a receptacle 118 for organizing the interchangeable bits and holding them in a stationary position. The inside of handle 104 can contain multiple chambers 116, with each chamber 116 distinct from the other chambers 116 to prevent objects inserted in one chamber 116 from moving about inside handle 104.

A hinged lid 112 covers the opening of each chamber 116. Lid 112 is uniform in shape to peripheral wall 107, and on the side of lid 112 having hinge 120, there's a smooth transition between the peripheral wall 107 and lid 112. In other words, the portion of the peripheral wall 107 adjacent to lid 112 on the side with hinge 120 has substantially the same plan outline forming a smooth transition between peripheral wall 107 and lid 112. On the opposite side of lid 112, a lip 121 is provided to assist the user in opening lid 112.

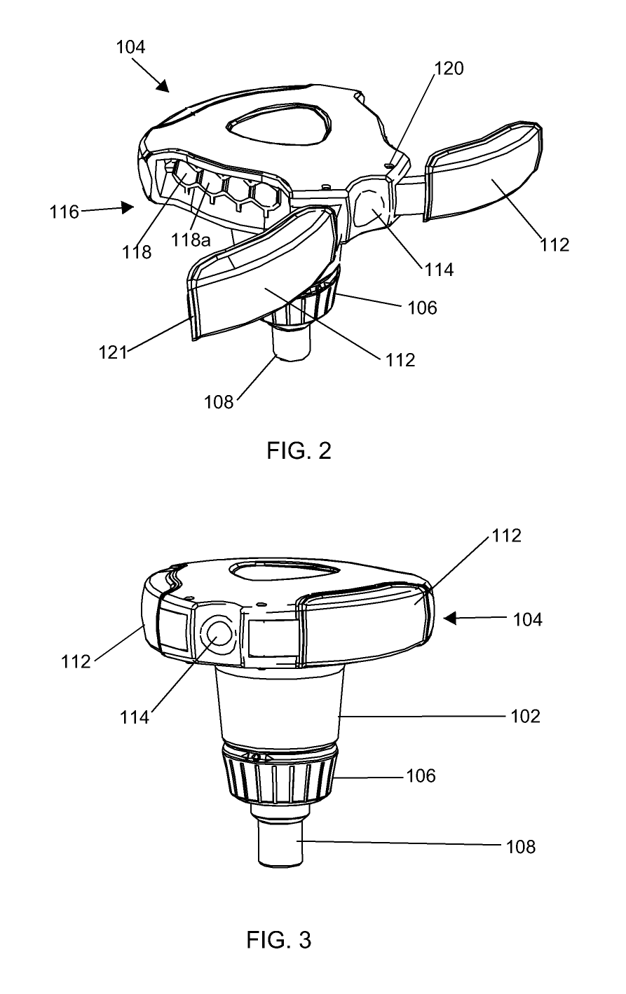

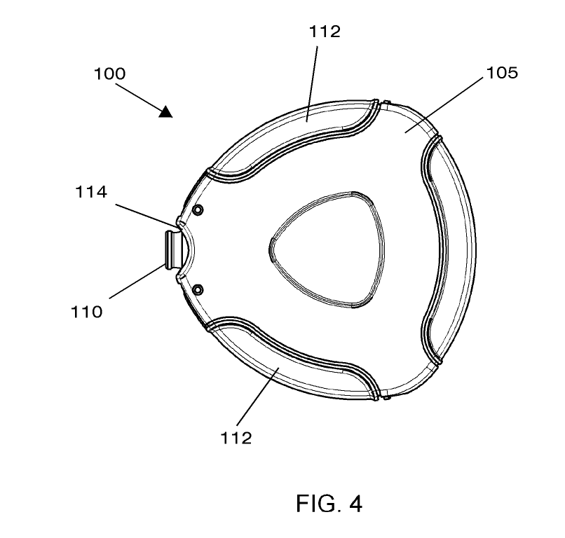

As previously stated, chambers 116 in handle 104 store interchangeable bits for driver 100. As illustrated in FIG. 2, chamber 116 contains receptacle 118 for selectively storing interchangeable bits in a stationary position. Preferably, receptacle 118 has a plurality of holes 118(a) sized to mate with the interchangeable bits of different sizes and hold them in a stationary position.

Driver 100 is held and gripped in the palm of the user's hand. It also shorter than standard ratcheting screwdrivers measured from top of handle 104 to ratcheting head 108. This advantageously allows the user to provide more torque to a fastener than otherwise might be possible with the standard ratcheting screwdriver; however, some situations call for a longer driver. In such instances, driver 100 is provided with a removable extension member 110 that is combinable with ratcheting head 108 of ratcheting mechanism 102. Extension member 110 extends the overall length of driver 100.

When extension member 110 is not in use, handle 104 is provided with an inconspicuous storage area for the extension member 110, so that the extension member 110 is available and easily accessible upon demand. An extension member storage receptacle 114 is disposed in a smooth concave recess extending into handle 104 of peripheral wall 107.

While the present invention has been particularly shown and described with reference to exemplary embodiments thereof, it should be understood by those of ordinary skill in the art that various changes, substitutions and alterations can be made herein without departing from the scope of the invention as defined by appended claims and their equivalents. The invention can be better understood by reference to the following claims. For purpose of claim interpretation, the transitional phrases “including” and “having” are intended to be synonymous with the transitional phrase “comprising.”

What is claimed is:

1. An ergonomic handle for a rotatable device comprising:
a handle body having an underside, an opposed upperside adapted to be received in the palm of a user's hand, and a peripheral wall extending between the underside and the upperside;
a ratcheting mechanism combined with the underside, the ratcheting mechanism having an axis of rotation extending substantially centrally through the underside and the upperside;
at least one chamber disposed within the handle body between the underside and the upperside; and
a lid combined with the peripheral wall providing for access to the at least one chamber, wherein the chamber is adapted for storing bits for the ratcheting mechanism.

2. The ergonomic handle for a rotatable device of claim 1, wherein the upperside has a slightly convex shape to be received in the palm of the user's hand.

3. The ergonomic handle for a rotatable device of claim 1, and further comprising a plurality of chambers disposed within the handle body between the underside and the upperside, wherein the plurality of chambers are distinct from each other and each having a lid to enable the user to selectively open and close the chamber.

4. The ergonomic handle for a rotatable device of claim 3, wherein the portion of the peripheral wall adjacent to at least one side of the lid has substantially the same plan outline as at least one side of the lid, thereby forming a smooth transition between the peripheral wall and the lid.

5. The ergonomic handle for a rotatable device of claim 1, wherein the portion of the peripheral wall adjacent to at least one side of the lid has substantially the same plan outline as at least one side of the lid, thereby forming a smooth transition between the peripheral wall and the lid.

6. The ergonomic handle for a rotatable device of claim 1, and further comprising a receptacle in the chamber for selectively storing interchangeable bits in a stationary position inside the chamber.

7. The ergonomic handle for a rotatable device of claim 1, wherein the lid is pivotally attached to the handle body.

8. The ergonomic handle for a rotatable device of claim 1, wherein the peripheral wall has a curved non-angular shape.

9. The ergonomic handle for a rotatable device of claim 1, and further comprising an extension member combined with the ratcheting mechanism to extend the length of the rotatable device.

10. The ergonomic handle for a rotatable device of claim 9, and further comprising an extension member storage receptacle within the handle body.

11. The ergonomic handle for a rotatable device of claim 10, wherein the extension member storage is a hole disposed in the peripheral wall and adapted to receive the extension member.

12. An ergonomic driver comprising:
a rotatable drive mechanism having an axis of rotation;
a handle body combined with the drive mechanism, the handle body having an upperside adapted to receive the palm of a user's hand, an underside, and a peripheral sidewall extending therebetween;
a plurality of chambers disposed within the handle body between the upperside and the
underside; and
a plurality of lids equal in number to the plurality of chambers, wherein the plurality of lids are disposed between the upperside and the underside and adjacent to the peripheral wall and forming a substantially continuous non-angular surface.

13. An ergonomic driver of claim 12, wherein the upperside has a slightly convex shape to be received in the palm of the user's hand.

14. An ergonomic driver of claim 13, wherein the portion of the peripheral wall adjacent to at least one side of the lid has substantially the same plan outline as the at least one side of the lid, thereby forming a smooth transition between the peripheral wall and the lid.

15. An ergonomic driver of claim 14, and further comprising a receptacle in at least one of the plurality of chambers for selectively storing interchangeable bits in a stationary position inside the chamber.

16. An ergonomic driver of claim 15, wherein the lid is pivotally attached to the handle body.

17. An ergonomic driver of claim 16, wherein the peripheral wall has a curved non-angular shape.

18. An ergonomic driver of claim 17, and further comprising an extension member combined with the ratcheting mechanism to extend the length of the rotatable drive mechanism.

19. An ergonomic driver of claim 18, and further comprising an extension member storage receptacle within the handle body.

20. The ergonomic handle for a rotatable device of claim 19, wherein the extension member storage is a hole adapted to receive the extension member, wherein the hole is disposed in the peripheral wall.

21. An handle for a hand tool comprising:
a handle body having an underside, an opposed upperside, and a peripheral wall extending between the underside and the upperside, wherein the upperside having a convex shape being adapted to fit in a palm of a user's hand with fingers of the user's hand wrapping around the peripheral wall and engaging the underside so that user can apply torque to the handle for driving a rotary action of the hand tool;
at least one chamber disposed between the upperside and the underside of the handle body and accessible through a opening in the peripheral wall; and
a lid combined with the peripheral wall and pivoting on an vertical axis of rotation extending from the upperside to the lower side of the handle body, the lid providing selective access by the user to the at least one chamber, wherein the chamber is adapted for storing bits for the ratcheting mechanism.
